(19) United States
(12) Patent Application Publication
(10) Pub. No.: US 2023/0283495 A1
(43) Pub. Date: Sep. 7, 2023

(54) SYSTEMS AND METHODS FOR ANNOTATING ONLINE MEETINGS

(71) Applicant: Citrix Systems, Inc., Fort Lauderdale, FL (US)

(72) Inventors: Xuan Liu, Nanjing (CN); Chunhui Wu, Nanjing (CN); Wenshuang Zhang, Nanjing (CN)

(21) Appl. No.: 17/656,944

(22) Filed: Mar. 29, 2022

Related U.S. Application Data
(63) Continuation of application No. PCT/CN2022/078797, filed on Mar. 2, 2022.

(51) Int. Cl. H04L 12/18; G10L 15/26; G06F 40/20; G06V 30/10

(52) U.S. Cl. CPC H04L 12/1831; G10L 15/26; G06F 40/20; G06V 30/10

(57) ABSTRACT

According to some embodiments of the disclosure, a method includes: receiving, at a computing device, content of an online meeting; analyzing, by the computing device, the content to identify one or more topics communicated by one or more client devices participating in the online meeting; associating, by the computing device, ones of the one or more topics to one or more text segments of the content; and providing, by the computing device, annotations for the online meeting to at least one of the one or more client devices participating in the online meeting, the annotations representative of the one or more topics and the associated text segments.

### CROSS REFERENCE TO RELATED APPLICATIONS

This application is a continuation of and claims the benefit of PCT Patent Application No. PCT/CN2022/078797 filed on Mar. 2, 2022 in the English language in the State Intellectual Property Office and designating the United States, the contents of which are hereby incorporated herein by reference in its entirety.

### BACKGROUND

Organizations schedule meetings for a variety of reasons. For example, within a company, employees may attend monthly planning meetings, weekly status meetings, etc. Online or “virtual” meetings are an increasingly popular way for users to collaborate, particularly when they are in different locations. Online meeting services, such as TEAMS, ZOOM, and GOTOMEETING, may provide audio and video conferencing among other features. If a user joins an online meeting late or otherwise missing a portion of the meeting (e.g., due to a computer malfunction or network interruption), the user may fail to receive relevant information (e.g., audio and/or video content) communicated during that portion and, as a result, may be hindered from participating in the remainder of the meeting.

### SUMMARY

With existing systems and methods for providing online meetings, if a user joins a meeting late, it may be necessary to interrupt the meeting and repeat the missed meeting content before proceeding with the remainder of the meeting. Such interruptions can increase the duration of the online meeting, resulting in increased computing resource usage (e.g., network bandwidth and processor usage) and decreased user productivity. While existing online meeting systems may provide the ability to record meetings, recordings are typically not made automatically for all meetings and, even if a meeting is recorded, the recording may not be accessible until after the meeting has ended. Regardless, it can be time-consuming and inefficient for a user to review all of the missed meeting content to identify information relevant to the remainder of the meeting.

According to one aspect of the present disclosure, a method can include: receiving, at a computing device, content of an online meeting; analyzing, by the computing device, the content to identify one or more topics communicated by one or more client devices participating in the online meeting; associating, by the computing device, ones of the one or more topics to one or more text segments of the content; and providing, by the computing device, annotations for the online meeting to at least one of the one or more client devices participating in the online meeting, the annotations representative of the one or more topics and the associated text segments.

In some embodiments, receiving the content of the online meeting may include receiving the content of the online meeting from one of the one or more client devices participating in the online meeting. In some embodiments, receiving the content of the online meeting can include receiving the content of the online meeting from an online meeting service.

In some embodiments, the content of the online meeting may be a first portion of content of an online meeting communicated during a first time period, the one or more topics can be one or more first topics, the one or more text segments can be one or more first text segments, and the annotations are first annotations further representative of the first time period, and the method can further include: receiving a second portion of content of the online meeting associated with a second time period; analyzing the second portion of the content to identify one or more second topics communicated by the one or more client devices participating in the online meeting; associating ones of the one or more second topics to one or more second text segments of the second portion of the content; and providing second annotations for the online meeting to the at least one of the one or more client devices participating in the online meeting, the second annotations representative of the one or more topics and the associated text segments, and further representative of the second time period.

In some embodiments, analyzing the content to identify the one or more topics may include: obtaining text of the content; and analyzing the text to identify the one or more topics. In some embodiments, analyzing the content to identify the one or more topics can include utilizing a trained topic model to identify the one or more topics within the text of the content. In some embodiments, associating one of the one or more topics to the one or more text segments of the content may include: splitting the text of the content into the one or more text segments using natural language processing (NLP); and performing a string search of the one of the one or more topics within the one or more text segments. In some embodiments, the content can include audio data, and obtaining text of the content can include performing speech-to-text on the audio data. In some embodiments, the content may include video or image data, and obtaining text of the content may include performing optical character recognition (OCR) on the image data.

According to another aspect of the present disclosure, another method can include: receiving, by a client device, annotations for an online meeting from a server device, the annotations representing topics and associated text segments identified by the server device based on analysis of content of the online meeting; and displaying, by the client device, the annotations positioned along a timeline of the online meeting to indicate during which time periods of the online meeting the topics and associated text segments were communicated by one or more other client devices participating in the online meeting.

In some embodiments, this other method can further include: detecting that a meeting application running on the client device is participating in the online meeting; and responsive to the detection, sending a request to the server device to retrieve the annotations for the online meeting. In some embodiments, this other can further include: periodically sending additional requests to the server device to retrieve additional annotations for the online meeting; and displaying the additional annotations alone the timeline of the online meeting. In some embodiments of this other method, the annotations may be displayed within the meeting application.

According to another aspect of the present disclosure, an apparatus can include a processor and a non-volatile memory storing computer program code that when executed on the processor causes the processor to execute a process that corresponds to any of the aforementioned methods or embodiments thereof.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the following claims.

### BRIEF DESCRIPTION OF THE DRAWINGS

The manner of making and using the disclosed subject matter may be appreciated by reference to the detailed description in connection with the drawings, in which like reference numerals identify like elements.

FIG. 1 is a diagram illustrating an example network environment of computing devices in which various aspects of the disclosure may be implemented, in accordance with an embodiment of the present disclosure.

FIG. 2 is a block diagram illustrating selective components of an example computing device in which various aspects of the disclosure may be implemented, in accordance with an embodiment of the present disclosure.

FIG. 3 is a diagram of a cloud computing environment in which various aspects of the concepts described herein may be implemented.

FIG. 4 is a network diagram of a system for annotating online meetings, according to some embodiments of the present disclosure.

FIG. 4A is block diagram of a system for annotating online meetings wherein meeting content is captured by a client and sent to a server, according to some embodiments of the present disclosure.

FIG. 4B is a block diagram of a system for annotating online meetings within which meeting content is synchronized between an online meeting service and a server, according to some embodiments of the present disclosure.

FIGS. 5A, 5B, and 5C are diagrams showing a user interface (UI) for presenting annotations generated for an online meeting, according to some embodiments of the present disclosure.

FIG. 6 is a diagram of another user interface (UI) for presenting annotations generated for an online meeting, according to some embodiments of the present disclosure.

FIG. 7 is an interaction diagram showing interactions that can occur within a system for annotating online meetings, according to some embodiments of the present disclosure.

FIG. 8 is a flow diagram of a method for annotating online meetings that may be performed by a server, according to some embodiments of the present disclosure.

FIG. 9 is a flow diagram of a method for annotating online meetings that may be performed by a client, according to some embodiments of the present disclosure.

The drawings are not necessarily to scale, or inclusive of all elements of a system, emphasis instead generally being placed upon illustrating the concepts, structures, and techniques sought to be protected herein.

### DETAILED DESCRIPTION

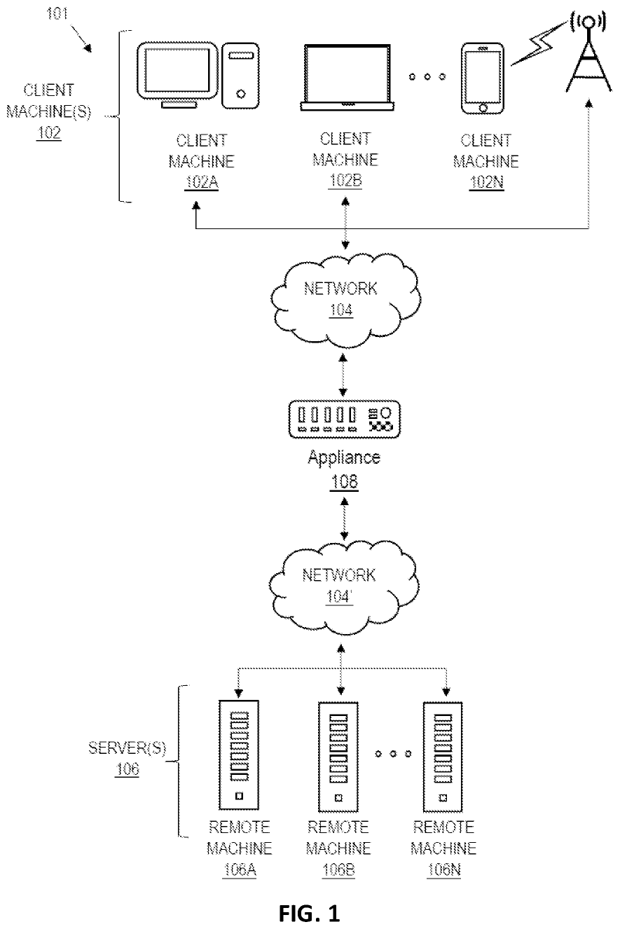

Referring now to FIG. 1, shown is an example network environment 101 of computing devices in which various aspects of the disclosure may be implemented, in accordance with an embodiment of the present disclosure. As shown, environment 101 includes one or more client machines 102A-102N, one or more remote machines 106A-106N, one or more networks 104, 104′, and one or more appliances 108 installed within environment 101. Client machines 102A-102N communicate with remote machines 106A-106N via networks 104, 104′.

In some embodiments, client machines 102A-102N communicate with remote machines 106A-106N via an intermediary appliance 108. The illustrated appliance 108 is positioned between networks 104, 104′ and may also be referred to as a network interface or gateway. In some embodiments, appliance 108 may operate as an application delivery controller (ADC) to provide clients with access to business applications and other data deployed in a datacenter, a cloud computing environment, or delivered as Software as a Service (SaaS) across a range of client devices, and/or provide other functionality such as load balancing, etc. In some embodiments, multiple appliances 108 may be used, and appliance(s) 108 may be deployed as part of network 104 and/or 104′.

Client machines 102A-102N may be generally referred to as client machines 102, local machines 102, clients 102, client nodes 102, client computers 102, client devices 102, computing devices 102, endpoints 102, or endpoint nodes 102. Remote machines 106A-106N may be generally referred to as servers 106 or a server farm 106. In some embodiments, a client device 102 may have the capacity to function as both a client node seeking access to resources provided by server 106 and as a server 106 providing access to hosted resources for other client devices 102A-102N. Networks 104, 104′ may be generally referred to as a network 104. Networks 104 may be configured in any combination of wired and wireless networks.

Server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

Server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, server 106 may execute a remote presentation services program or other program that uses a thin-client or a remote-display protocol to capture display output generated by an application executing on server 106 and transmit the application display output to client device 102.

In yet other embodiments, server 106 may execute a virtual machine providing, to a user of client device 102, access to a computing environment. Client device 102 may be a virtual machine. The virtual machine may be managed by, for example, a hypervisor, a virtual machine manager (VMM), or any other hardware virtualization technique within server 106.

In some embodiments, network 104 may be: a local-area network (LAN); a metropolitan area network (MAN); a wide area network (WAN); a primary public network; and a primary private network. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

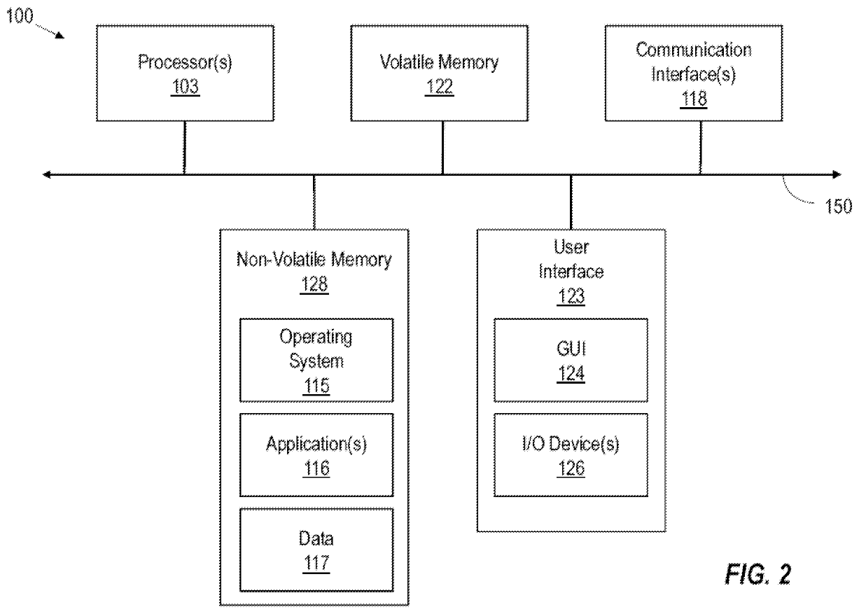

FIG. 2 is a block diagram illustrating selective components of an example computing device 100 in which various aspects of the disclosure may be implemented, in accordance with an embodiment of the present disclosure. For instance, client devices 102, appliances 108, and/or servers 106 of FIG. 1 can be substantially similar to computing device 100. As shown, computing device 100 includes one or more processors 103, a volatile memory 122 (e.g., random access memory (RAM)), a non-volatile memory 128, a user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

Non-volatile memory 128 stores an operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computing device 100 may communicate via communications bus 150.

The illustrated computing device 100 is shown merely as an example client device or server and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 103 may be analog, digital or mixed-signal. In some embodiments, processor 103 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described embodiments, computing device 100 may execute an application on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

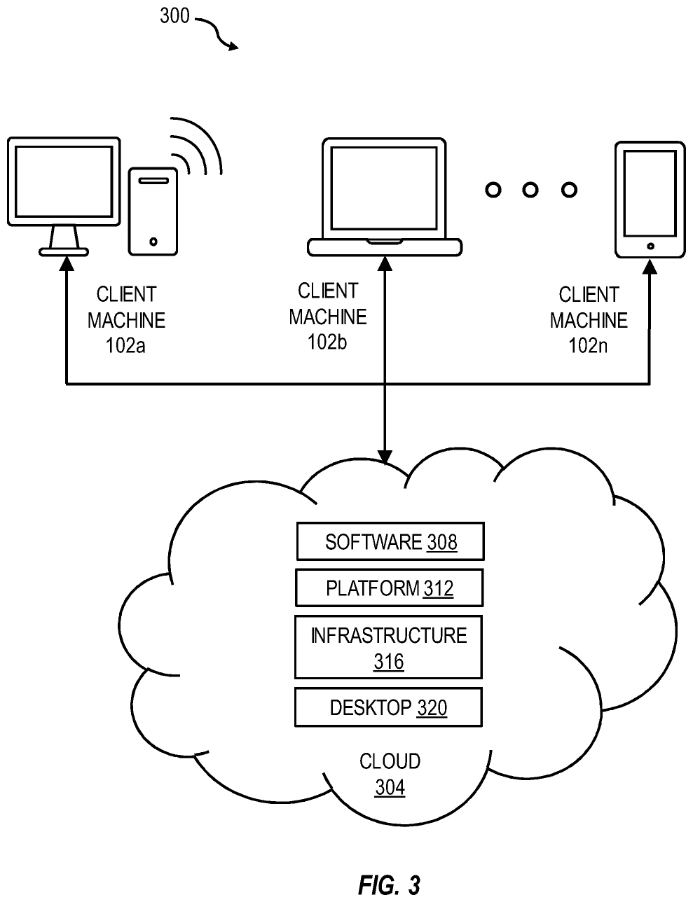

Referring to FIG. 3, a cloud computing environment 300 is depicted, which may also be referred to as a cloud environment, cloud computing or cloud network. The cloud computing environment 300 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 300, one or more clients 102a-102n (such as those described above) are in communication with a cloud network 304. The cloud network 304 may include back-end platforms, e.g., servers, storage, server farms or data centers. The users or clients 102a-102n can correspond to a single organization/tenant or multiple organizations/tenants. More particularly, in one example implementation the cloud computing environment 300 may provide a private cloud serving a single organization (e.g., enterprise cloud). In another example, the cloud computing environment 300 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 300 may provide a hybrid cloud that is a combination of a public cloud and a private cloud. Public clouds may include public servers that are maintained by third parties to the clients 102a-102n or the enterprise/tenant. The servers may be located off-site in remote geographical locations or otherwise.

The cloud computing environment 300 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 300 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 300 can provide an elasticity to dynamically scale out or scale in response to different demands from one or more clients 102. In some embodiments, the cloud computing environment 300 can include or provide monitoring services to monitor, control and/or generate reports corresponding to the provided shared services and resources.

In some embodiments, the cloud computing environment 300 may provide cloud-based delivery of different types of cloud computing services, such as Software as a service (SaaS) 308, Platform as a Service (PaaS) 312, Infrastructure as a Service (IaaS) 316, and Desktop as a Service (DaaS) 320, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

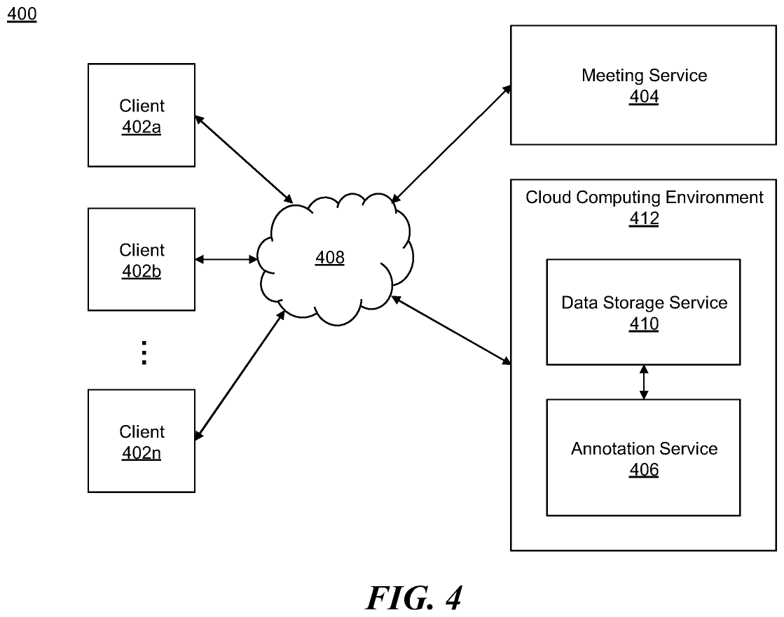

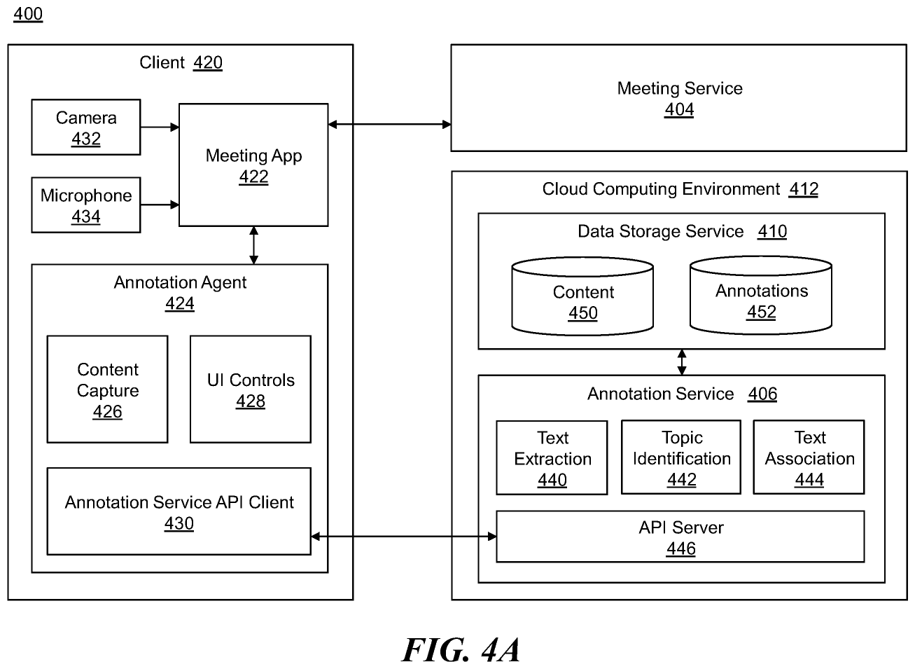

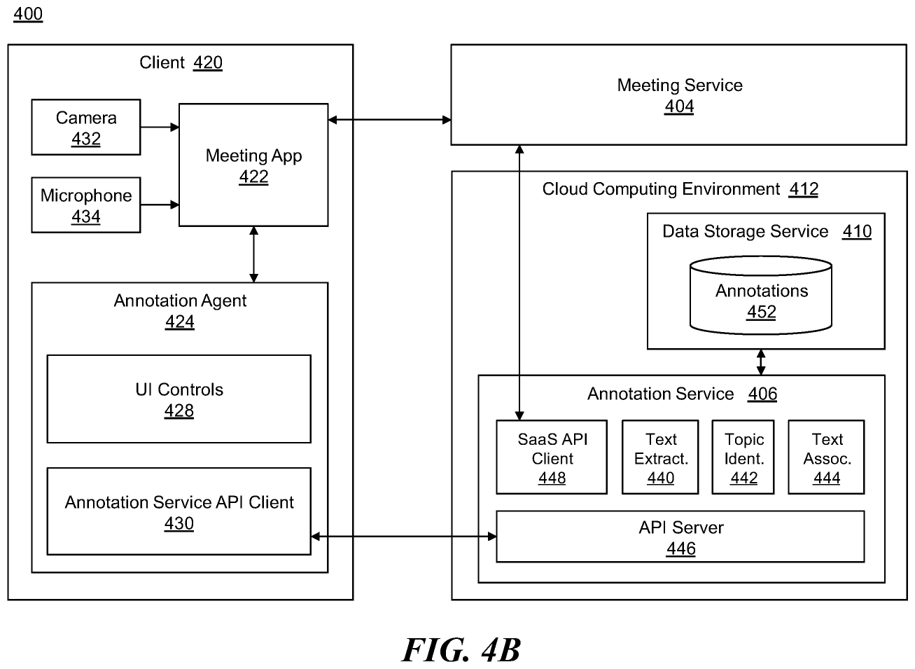

Turning to FIG. 4, embodiments of the present disclosure can automatically generate annotations generated for an online meeting based on analysis of the meeting's contents, and provide the generated annotations to one or more client devices during and/or after the meeting. The client device's may be configured to render the meeting's annotations within one or more UIs and, in some cases, to provide access to specific portions of the meeting's contents via interactions with corresponding ones of the automatically generated annotations.

FIG. 4 shows a system for annotating online meetings, according to some embodiments. Illustrative system 400 includes one or more clients 402a, 402b, . . . , 402n (402 generally) connected to an online meeting service 404 and an annotation service 406 via one or more computer networks 408. Online meeting service (or “meeting service”) 404 may correspond to a service that provides audio and video conferencing such as TEAMS, ZOOM, or GOTOMEETING. Meeting service 404 can provide an interface via which clients 402 can host and participant in online meetings (or “meetings”). The interface may comprise, for example, an application programming interface (API) and/or a GUI or other type of UI. Annotation service 406 can include software configured to automatically generate annotations for online meetings hosted by meeting service 404 and to provide the generated annotations to clients 402 during and/or after such meetings. As discussed in detail below, annotation service 406 can receive meeting content from ones of the clients 402 and/or from meeting service 404 and, based on an analysis of the received content, can automatically generate annotations for the meeting. Clients 402 can receive meeting annotations from annotation service 406 and present them within one or more different UIs.

As shown in the embodiment of FIG. 4, annotation service 406 can be hosted within a cloud computing environment 412 that provides various other resources such as a data storage service 410. In other embodiments, annotation service 406 and/or data storage service 410 may be provided within an on-premises data center. In general, annotation service 406 can run on, or correspond to, any type of server device.

In some embodiments, clients 402 may be the same as or similar to clients 102 of FIG. 1 and/or FIG. 3. In some embodiments, clients 402, annotation service 406, and/or data storage service 410 can comprise various hardware and software elements such as those described above for computing device 100 of FIG. 2. In some embodiments, cloud computing environment 412 may be the same as or similar to cloud network 304 of FIG. 3.

FIGS. 4A and 4B show detailed views of system 400 in which like elements of FIG. 4 are shown using like reference designators, according to embodiments of the present disclosure. In the embodiment of FIG. 4A, meeting content is captured by the client and sent to the annotation service. In the embodiment of FIG. 4B, meeting content is synchronized between the online meeting service and the annotation service. The illustrated embodiments are not intended to be mutually exclusive, and structures and techniques described below in conjunction with one embodiment can be utilized within the other embodiment.

Turning to FIG. 4A, a client 420 is shown connected to the meeting service 404 and the annotation service 406. The illustrative client 420—which can correspond to any or all of clients 402 of FIG. 4—can include a meeting application 422, an annotation agent 424, a camera 432, a microphone 434, and various other hardware and software components not shown for the sake of clarity.

The meeting application 422 can correspond to an application configured to interface with meeting service 404 to enable client 420 to host and/or participant in online meetings. For example, in the case where meeting service 404 is TEAMS, the meeting application 422 may correspond to a TEAMS client application. Likewise, meeting application 422 can correspond to a ZOOM client application or a GOTOMEETING client application. In some embodiments, meeting application 422 may be provided as a web application running within a web browser installed on client 420.

When participating in an online meeting, meeting application 422 can receive content from local client 420 and content from other, remote clients via meeting service 404. For example, the meeting content received from client 420 can include video data and audio data recorded by camera 432 and microphone 434, respectively, and the meeting content received from other clients can include video data and audio data recorded by cameras and microphones of the other clients and transmitted to client 420 via meeting service 404. In the case where screen sharing is used during a meeting, client 420 can receive images representing the appearance and content of one or more application windows running on client 420 and/or other clients. Meeting application 522 can provide one or more UIs for displaying the image/video content and may be configured to output audio content to a speaker connected to client 420.

In some embodiments, annotation agent 424 can be provided as a plugin or extension to the meeting application 422 or otherwise integrated there within. Various existing meeting applications provide mechanisms for adding functionality thereto. For example, TEAMS allows different types of “apps” to be loaded within the TEAMS client application including “tabs” apps that allow for the presentation of UI controls not otherwise provided by the TEAMS client application. ZOOM and other meeting applications may provide similar mechanisms for extending the functionality thereof. In other embodiments, annotation agent 424 may be provided as a standalone application that interfaces with the meeting application. In some embodiments, annotation service 406 can be provided as a service (e.g., a microservice) within the cloud computing environment 412.

Annotation agent 424 and annotation service 406 can interoperate to automatically generate annotations for online meetings hosted by meeting service 404 and to present UI controls on the client 420 (e.g., within a tab, screen, or other interface of meeting application 422) for displaying the annotations and, in some cases, for accessing to correspond portions of the meeting content. In more detail, annotation agent 424 can capture meeting content (e.g., audio, video, and/or image data) presented by meeting application 422 and transmit the captured meeting content to annotation service 406 via an API. In response, annotation service 406 can analyze the meeting content, or portions thereof, to generate annotations using techniques described hereinbelow.

An annotation can include a topic (e.g., a keyword or phrase) and one or more text segments (e.g., sentences or paragraphs) extracted from the meeting content that reference that topic. For example, assume the following statements were communicated during a portion of a meeting (e.g., are encoded within audio data generated by one or more clients participating in that portion of the meeting):
“Let's discuss running jobs using Quick Delivery. I think that is an important next step in this project.
Yes, good idea. I agree it's important.
The first thing we should do is convert our VMs to use Quick Delivery templates.”
   In this example, annotation service 406 might generate an annotation (e.g., a data structure representing an annotation) that includes or otherwise represents the topic “Quick Delivery” and the following text segments: (1) “Let's discuss running jobs using Quick Delivery,” and (2) “The first thing we should do is convert our VMs to use Quick Delivery templates.” Annotation service 406 can use one or more natural language processing (NLP) techniques to identify topics discussed, presented, or otherwise communicated within the meeting content (e.g., topics that are likely relevant or of importance to meeting's participants). Examples of such NLP techniques are described in detail below. An annotation can also include a timestamp or other value indicating when during the meeting the topic was communicated, as discussed further below.

Annotation service 406 can send the generated annotations to annotation agent 424, which in turn can present one or more UIs that display the annotations and, in some cases, enable access to the corresponding portions of the meeting content in response to inputs on the meeting annotations. In some embodiments, the UIs may be presented within the meeting application 422 running on client 420. In some embodiments, the UIs may be presented within a resource access application running on client 420, such as CITRIX WORKSPACE.

Annotation agent 424 and annotation service 406 can be logically and/or physically organized into one or more components. In the example of FIG. 4A, annotation agent 424 includes a content capture module 426, UI controls 428, and an annotation service API client 430. Also in this example, annotation service 406 includes a text extraction module 440, a topic identification module 442, a text association module 444, and an API server 446. The client-side annotation agent 424 and server-side annotation service 406 can communicate using an API implemented by API server 446 and API client 430. For example, annotation agent 424 can send captured meeting content to annotation service 406 within an API message, and annotation service 406 can send generated annotations to annotation agent 424 as a response to that API message or via another API message. An API message sent between annotation agent 424 and annotation service 406 may include a unique identifier for a meeting (e.g., a unique identifier generated by meeting service 404 and obtained by annotation agent 424 via meeting application 422).

In some embodiments, annotation agent 424 may detect when client 420 joins or otherwise begins participating in an online meeting using meeting application 422. In response to detecting participation in the meeting, annotation agent 424 can send an API message to annotation service 406 to request annotations that were previously generated for the meeting. In this way, a participant who joins a meeting late or otherwise misses a portion of a meeting can be automatically presented with information about relevant topics already previously during the meeting. In some embodiments, annotation agent 424 can interface with meeting application 708 to detect when client 420 joins a meeting. For example, meeting application 708 may provide an event handler interface that can be used to detect when particular types of events are triggered within the meeting application 708 (i.e., to “listen” for particular types of events). Using such an interface, annotation agent 424 can listen for one or more events that indicate client 420 has joined or is otherwise begins participating (e.g., a “connect” event, a “join” event, etc.)

Referring to client 420, content capture module 426 is operable to receive (or “capture”) the contents of meetings presented by meeting application 422. Such content can include, for example, audio, video, and/or images data received from local client 420 and/or the same received from other, remote clients. Content capture module 426 may utilize an API provided by meeting application 422 to capture meeting content presented there within. Content capture module 426 can send capture meeting content to annotation service 406 using API client 430 such that annotation service 406 can record and analyze the captured meeting content to generate annotations thereof. In some embodiments, content capture module 426 may send meeting content to annotation service 406 on a continuous basis, for example by streaming the captured content to annotation service 406. In other embodiments, content captured module 426 may send meeting content to annotation service 406 on a periodic basis, for example by buffering the content and sending it after N minutes have elapsed, where N=1, 2, 3, 5, 10, 15, 20, etc. Some meeting applications/services may provide an API for retrieving the content of meeting in text form. For example, meeting application 422 and/or meeting service 404 may be configured to perform speech-to-text on the audio content of a meeting. In such cases, the meeting content captured by module 426 and sent to annotation service 406 may include text content. In other cases, non-text content may be converted to text as discussed below.

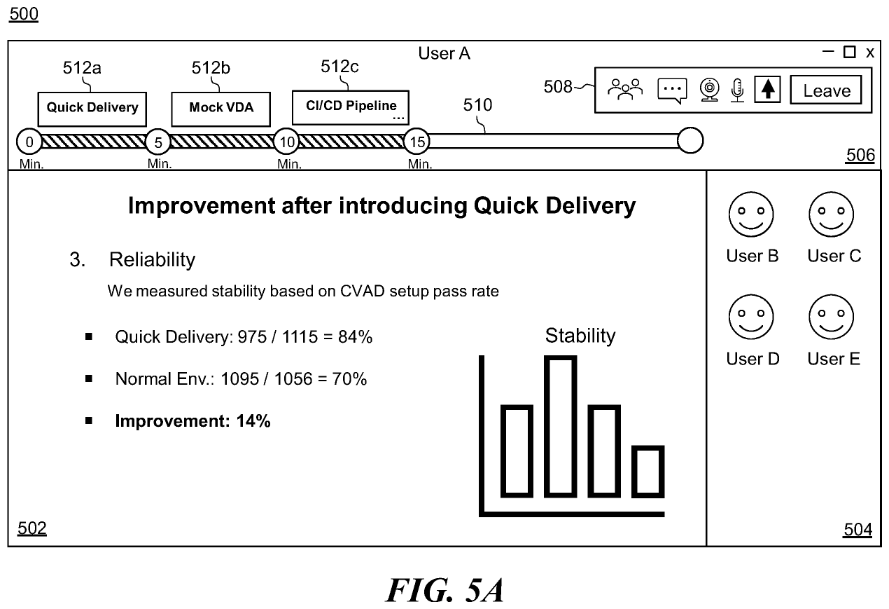

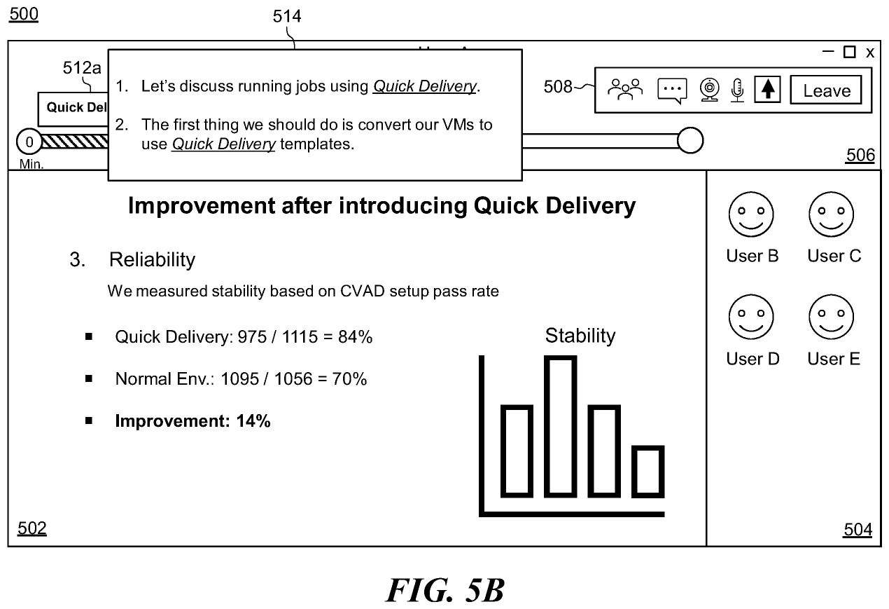

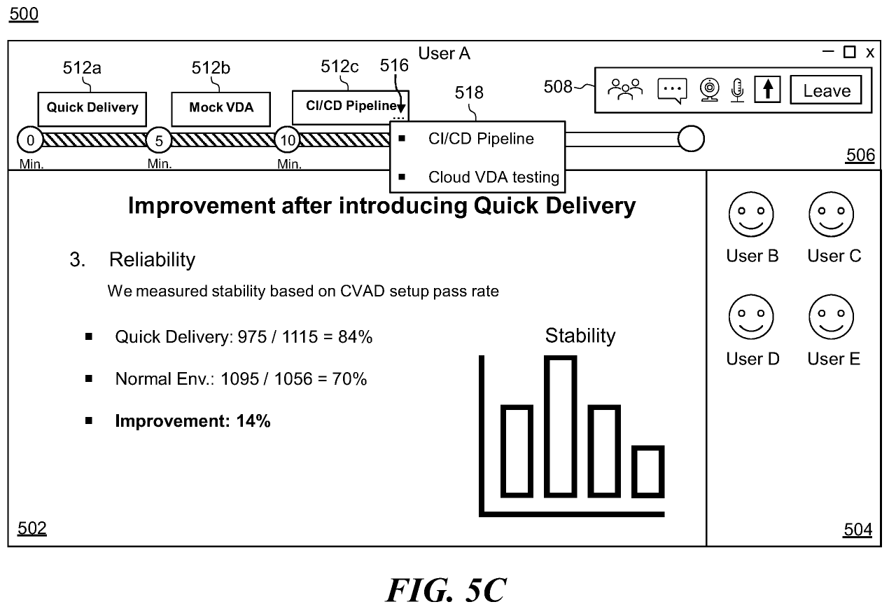

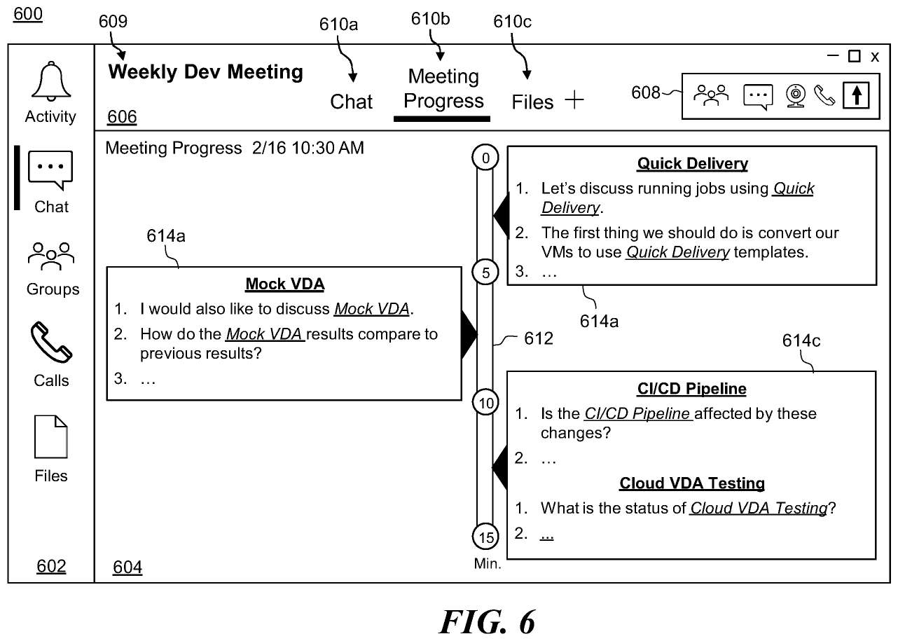

UI controls 428 can include various controls for displaying meeting annotations generated by annotation service 406 and, in some cases, for accessing to corresponding portions of the meeting content in response to inputs on the meeting annotations. For example, UI controls 418 can include labels for displaying the topics represented by the annotations, where the topic labels are positioned along a timeline of the meeting to indicate when during the meeting the topics were discussed, presented, or otherwise communicated (e.g., which time periods or portions of the meeting the topics were communicated during). In some embodiments, in response to a click, tap, or other input on a topic label, UI controls 418 can present additional labels for displaying text segments of the meeting's content that are associated with that topic. For example, the topic label can visually expand to show the corresponding text segments in response to an input. In some embodiments, in response to an input on a topic label or on a text segment label, UI controls 418 can cause a corresponding portion of the meeting content to be played back, displayed, or otherwise accessed. Annotation agent 424 can update the state of UI controls 428 in response to receiving meeting annotations from annotation service 406 during the meeting and/or after the meeting. For example, when client 420 joins a meeting, annotation agent 424 can render any annotations previously generated for that meeting and can periodically render additional annotations generated during the remainder of the meeting. In some embodiments, UI controls 428 can implement any or all of the UIs show in FIGS. 5A, 5B, 5C, and 6 and described below in the context thereof.

Turning to cloud computing environment 412, annotation service 470 is operable to receive meeting content (e.g., audio, video, and/or image data) from annotation agent 424 and to store (or “record”) the meeting content in a content store 450. Content store 450 can be provided as, for example, a file system or an object store (sometimes referred to as “blob” storage). Content store 450 may be configured to store the contents of one or more meetings and to index the stored content using unique meeting identifiers. In some embodiments, all of the content for a meeting may be stored as a single file/object within content store 450. In other embodiments, the content for a meeting may be divided into segments and the segments may be stored as separate files/objects within content store 450. For example, the meeting content can be divided into segments having to equal durations (e.g., each segment can correspond to N minutes of content). Content store 450 and may be provided by data storage service 410 of cloud computing environment 412, as shown. In some embodiments, annotation service 406 may store meeting content within memory allocated to annotation service 406 and, thus, content store 450 may be omitted.

Text extraction module 440 can convert meeting content received by annotation service 406 (e.g., content stored in content store 450 or memory) to text. That is, text extraction module 440 can “extract” some or all text communicated within the meeting content. In the case of audio content, text extraction module 440 can utilize a speech-to-text application or library. Any open-source or proprietary application/library capable of converting speech to text can be used. In the case of video or image content, text extraction module 440 can utilize optical character recognition (OCR) to extract text from the video/image content. As previously discussed, some meeting applications/services may provide an API for retrieving the content of meeting in text form. In such cases, the meeting content received from annotation agent 424 may be in text form and, thus, text extraction module 440 can be omitted or not used.

Topic identification module 442 can analyze text extracted from meeting content to identify one or more topics communicated within that content. In some embodiments, an NLP technique can be used to identify topic. For example, a topic model can be used in some embodiments. A topic model is a generative statistical model that can be used to identify or explain similarities between sets of observations. A topic model posits that a collection of text (or “document”) is a combination of a small number of topics and that each word's presence is attributable to one of the document's topics. A topic model can be trained so as to predict/identify the topics within a given document. Topic identification module 442 can treat text extracted from a portion of meeting content (e.g., from N minutes of meeting content) as a document that is input to the topic model and, in response, receive one or more topics as output. In some embodiments, topic identification module 442 can use an open-source library to implement topic modelling, such as the GENSIM library for Python. In some embodiments, topic identification module 442 can use latent Dirichlet allocation (LDA) to identify topics from the text extracted from meeting content.

Topic identification module 442 can use a topic model that has been trained for a particular language corresponding to the language in which the meeting is conducted and/or may use a multilingual topic model. In some embodiments, annotation service 406 may be used by multiple organizations and may allow different organizations to use different trained models. For example, annotation service 406 may include or otherwise have access to a set of trained topic models and may maintain a mapping between organizations and models, where the mapping can be adjusted via a preferences UI or other interface. As another example, annotation service 406 may provide an interface for uploading trained models to be used for particular organizations. The trained models can be stored in, and accessed from, data storage service 410 and/or a memory of annotation service 406.

Text association module 444 can associate topics identified for particular meeting content to specific segments of text extracted from that meeting content. For example, text association module 444 can receive extracted text from text extraction module 440 and identified topics from topic identification module 442, and can determine which segments of the text reference or are otherwise associated with which topics. The text segments can include sentences, paragraphs, or any other types of natural language segmentations. To perform the association, text association module 444 can first split the text into one or more segments using NLP. For example, text association module 444 can split the text into sentences using the Natural Language Toolkit (NLTK) for Python or a similar open-source NLP toolkit. Next, text association module 444 can use a string-search algorithm to determine which of the identified topics appear in which of the text segments. For example, for each topic and for each text segment, text association module 444 can execute a string-search algorithm to determine if that topic appears in or is otherwise referenced by that text segment. Text association module 444 can consider a particular text segment to be associated with a particular topic if, according to the string-search algorithm, the topic appears within/is referenced by the text segment. In some embodiments, text association module 444 may use a string-search algorithm that performs exact matching, such as the Boyer-Moore string-search algorithm. In some embodiments, text association module 444 may use a string-search algorithm that performs approximate (or “fuzzy”) matching.

To further illustrate operation of modules 442 and 444, consider the following text that is assumed to have been extracted from meeting content (e.g., N minutes of meeting content):
“Let's discuss running jobs using Quick Delivery. I think that is an important next step in this project.
Yes, good idea. I agree it's important.
The first thing we should do is convert our VMs to use Quick Delivery templates.
I would also like to discuss Mock VDA. We have been seeing great results using that new tool.
How do the Mock VDA results compare to previous results?”
   With this illustrative text, topic identification module 442 may identify the topics “Quick Delivery” and “Mock VDA” using LDA or another topic modelling technique. Then, text association module 444 may form the following associations between topics and sentences (i.e., segments):
1. “Quick Delivery”: [“Let's discuss running jobs using Quick Delivery.”, “The first thing we should do is convert our VMs to use Quick Delivery templates.”]
2. “Mock VDA”: [“I would also like to discuss Mock VDA.”, “How do the Mock VDA results compare to previous results?”]

Using the topics identified by module 442 and the text segments associated therewith by module 444, annotation service 406 can generate and store meeting annotations within an annotations database 452. Annotations database 452 may correspond to, for example, a relational database or other type of structured database. As shown in the embodiment of FIG. 4A, annotations database 452 may be provided by data storage service 410 of cloud computing environment 412.

For a particular meeting, annotation service 406 can invoke modules 440, 442, and 444 multiple times to generate annotations for different portions of the meeting's content. For example, as a meeting is in progress, annotation agent 424 can send new meeting content to annotations service 406 every N minutes. In response, annotation service 406 can invoke text extraction module 440 to convert the past N minutes of content to text, topic identification module 442 to identify topics with the past N minutes of content, and text association module 444 to associate segments of the text with topics. Based on the results of this processing, annotation service 406 can generate and store annotations generated for the past N minutes of content to annotations database 452. Annotation service 406 can then send the annotations generated from the past N minutes of meeting content to annotation agent 424 where they can be displayed, for example, along a timeline of the meeting in progress. If other clients join the meeting, they can obtain annotations previously generated for the meeting from annotation service 406 and render the annotations within one or more UIs.

An annotation generated and stored for a portion of a meeting's content can be logically represented as a 4-tuple having the following elements: (1) a unique identifier for the meeting; (2) a topic; (3) one or more text segments associated with the topic; and (4) a timestamp or other value indicating when during the meeting the topic was communicated (i.e., which portion or time period of the meeting the topic is associated with). In the case where annotation service 406 analyzes portions of a meeting's content having equal durations (e.g., N minutes each), element (3) may correspond to a sequence number indicating which portion of content was analyzed to identify the corresponding topic. For example, annotations generated from the first N minutes of the meeting's content may be assigned a sequence number of zero (0), annotations generated from minutes N+1 to 2N be assigned a sequence number of one (1), etc.

Returning to client 420, in some embodiments, annotation agent 424 may be configured to access specific portions of meeting content in response to inputs on corresponding annotations displayed by UI controls 428. For example, in response to a click, tap, or other input on a displayed annotation (or topic or text segment thereof), annotation agent 424 can send an API request to annotation service 406 to retrieve the corresponding portion of meeting content from which the annotation was generated from content store 450. As another example, the meeting content may be retrieved from meeting service 404. As discussed further below in conjunction with FIG. 6, the retrieved meeting content can be displayed or otherwise presented by client 420.

In some embodiments, some or all of the processing described for annotation service 406 can be implemented within the client-side annotation agent 424. For example, text extraction module 440, topic identification module 442, and/or text association module 444 may be implemented as sub-modules of annotation agent 424 and configured to execute on client 501 (instead of within cloud computing environment 412). In such embodiments, API client 430 and API server 446 may be omitted from system 400.

FIG. 4B shows another embodiment of system 400 for annotating online meetings. In the embodiment of FIG. 4B, meeting content can be synchronized directly between online meeting service 404 and annotation service 406 within cloud computing environment 412. In more detail, annotation service 406 can include a SaaS API client 448 configured to request meeting content from meeting service 404 using an API provided thereby. For example, SaaS API client 448 may implement a RESTful API or an RPC interface provided by TEAMS, ZOOM, or GOTOMEETING. Annotation service 406 can retrieve meeting content periodically (e.g., every N minutes) during a meeting in progress and/or may retrieve all content for a meeting after the meeting has completed. The content capture module 426 of client 420 and/or the content store 405 of cloud computing environment 412 may be omitted in the embodiment of FIG. 4B.

FIGS. 5A-5C show an example of a UI 500 for displaying annotations generated for an online meeting, according to some embodiments. The illustrative UI 500 includes a content display 502, a participant list 504, and a header area 506. Content display 502 can show, for example, images representing the appearance and content of one or more application windows running on a client participating in the meeting (e.g., images of a shared screen) and/or video captured by a camera connected to a client. Participant list 504 can show the names of the meeting's participants and corresponding icons. Header area 506 can include various meeting controls 508 along with a meeting timeline 510.

Meeting timeline 510 can include markers at regular time intervals, such as 5 minutes, 10 minutes, 15 minutes, etc. and may use different styling to indicate approximately how much time has elapsed in an in-progress meeting. For example, as shown in FIG. 5A, meeting timeline 510 may use hatching, coloration, or other styling to indicate that about 15 minutes have elapsed in a meeting. UI 500 can also include one or more topic labels 512a, 512b, 512c (512 generally) to display topics that were automatically identified within the content of a meeting using techniques and structures disclosed herein. For example, topic labels 512 may display topics of annotations generated by annotation service 406 of FIG. 4A.

Topic labels 512 may be positioned along meeting timeline 510 to indicate which portions of the meeting content the topics were identified in. For example, assuming that annotations were generated by analyzing consecutive five-minute portions of the meeting content, a first topic label 512a displaying the topic “Quick Delivery” can be positioned between the zero (0) and five (5) minute markers to indicate that the topic “Quick Delivery” was identified within the first portion of meeting content. Likewise, annotations labels 512b and 512c may be positioned along the timeline 510 to indicate that the topics “Mock VDA” and “CI/CD Pipeline” were identified within the second and portions of meeting content, respectively. As a meeting progresses, timeline 510 can be dynamically updated to display new annotations generated by analyzing recent meeting content. While only three (3) topic labels 512 are shown in the illustrative UI 500, generally any number of topic labels 512 can be shown.

In some embodiments, portions of UI 500 may correspond to a UI presented by a meeting application (e.g., meeting application 422 of FIG. 4A) whereas other portion of UI 500 may correspond to UI controls provided by a plugin or extension to the meeting application (e.g., by meeting annotation agent 424 of FIG. 4A). For example, the meeting application may present a UI that includes content display 502, participant list 504, and header area 506, whereas meeting timeline 510 and topic labels 512 may be provided as enhancements thereto.

Turning to FIG. 5B, in response to a click, tap, or other type of input on one of the topic labels 512, UI 500 may be configured to display the text segments associated with that annotation. For example, UI 500 may display text segments that were associated to the displayed topic using the techniques described in conjunction with module 444 of FIG. 4A. As shown in the example of FIG. 5B, the text segments may be displayed as an ordered list within a popup 514. In some embodiments, the associated topic may be stylized within the displayed text segments. For example, as shown in FIG. 5B, in response to an input on the first topic label 512a, UI 500 can display popup 514 within which the topic “Quick Delivery” is underlined and italicized in two associated text segments.

Turning to FIG. 5C, if multiple topics are identified within the same portion of meeting content, UI 500 may present controls for displaying and interacting with the multiple topics. In the example shown, it is assumed that two topics—“CI/CD Pipeline” and “Cloud VDA testing”—were identified during analyses of the third portion of the meeting content (i.e., between minutes 10 and 15 of the meeting). Due to limited screen space, third topic label 512c may display only one of these topics initially (e.g., in an initially state of the UI). In the example, shown, the topic “CI/CD Pipeline” is initially displayed. Various techniques can be used to select the topic that is initially displayed. For example, the topic that is appears most often within text being analyzed (e.g., the text extracted from the past N minutes of the meeting's content) may be initially displayed. In response to an input on ellipses 516 or another UI control associated with third topic label 512c, UI 500 can present a popup 518 showing all three of the identified topics. In other embodiments, a topic label may visually expand to show other topics in response to an input. UI 500 may be further configured to display text segments associated with a given one of those topics in response to an input thereon (e.g., by presenting a popup similar to popup 514 of FIG. 5B).

UI 500 provides an efficient way for a meeting participant (e.g., a participant that joins the meeting late) to become informed about which topics have been discussed in a meeting without causing interruption to the meeting.

FIG. 6 shows another UI 600 for displaying annotations generated for an online meeting, according to some embodiments of the present disclosure. The illustrative UI 600 includes a feature menu 602, a tab display 604, and a header area 606. Feature menu 602 can include bottoms, links, or other controls for accessing different features of the meeting application. As shown, feature menu 602 can include controls accessing the following features: “Activity,” “Chat,” “Groups,” “Calls,” and “Files.” In the example of FIG. 6 it is assumed that the Chat feature is selected and that, within the Chat feature, a particular meeting entitled “Weekly Dev Meeting” is selected (e.g., selected via a menu of past chats and meetings that is not shown for the sake of clarity).

Header area 606 can include various UI controls that change depending on the currently selected feature of the meeting application. For example, with the Chat feature selected, header area 606 can include a label 609 to display the name of a selected meeting, various meeting controls 608, and one or more tabs 610a, 610b, 610c (610 generally) for accessing different content of the meeting. As shown, tabs 610 can include a chat tab 610a, a meeting progress tab 610b, and a files tab 610c.

Tab display 604 can include various UI controls that change depending on which of the tabs 610 is currently selected. As shown, when the meeting progress tab 610b is selected, tab display 640 can include a meeting timeline 612 and one or more annotation displays 614a, 614b, 614c (614 generally) positioned along the meeting timeline 612. Meeting timeline 612 can include markers at regular time intervals, such as 5 minutes, 10 minutes, 15 minutes, etc. with the last marker indicating the approximate duration of the meeting (e.g., about 15 minutes in the example shown). Annotation displays 614 display annotation that were automatically identified within the content of a meeting using techniques and structures disclosed herein. For example, annotation displays 614 may display annotations generated by annotation service 406 of FIG. 4A.

Similar to the topic labels 512 of FIGS. 5A-5C, annotation displays 614 may be positioned along meeting timeline 612 to indicate which portions of the meeting content the topics were identified in. However, in contrast to the annotation labels 512 of FIGS. 5A-5C, annotation displays 614 can display both the identified topics and the associated text segments extracted from the meeting content. In further contrast, a given one of the annotation displays 614 can show multiple annotations. For example, annotation display 614c can display two annotations having the topics “CI/CD Pipeline” and “Cloud VDA Testing,” along with text segments associated with both topics. In some embodiments, in response to an input on a particular one of the annotation displays 614, UI 600 can cause the corresponding portion meeting's contents to be accessed from a content store (e.g., content store 450 of FIG. 4A) or from a meeting service (e.g., meeting service 404 of FIG. 4A).

In some embodiments, UI 600 may be used within a meeting application to display annotations for meetings that have completed. For example, when a meeting completes, UI 600 may be updated (e.g., by annotation agent 424) to show a timeline of the entire meeting and all of the annotations generated automatically from the meeting's content. In this way, UI 600 provides an efficient way for meeting participants to recall which topics were discussed without having to watch or listen to a full recording of the meeting.

In some embodiments, portions of UI 600 may correspond to a UI presented by a meeting application (e.g., meeting application 422 of FIG. 4A) whereas other portion of UI 600 may correspond to UI controls provided by a plugin or extension to the meeting application (e.g., by meeting annotation agent 424 of FIG. 4A). For example, the meeting progress tab 610b may be provided as an enhancement to an existing meeting application.

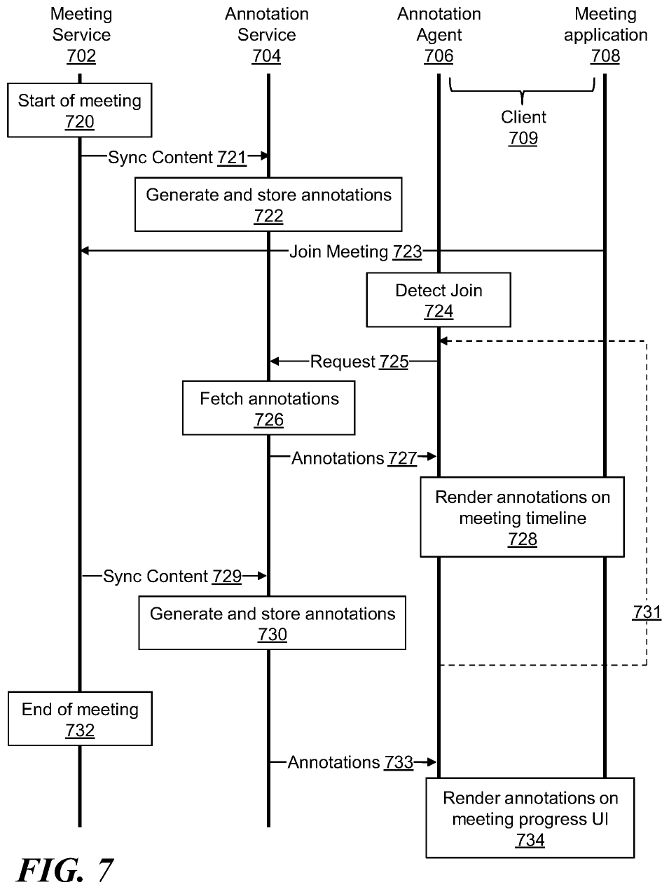

FIG. 7 shows interactions that can occur within a system for annotation online meetings (e.g., system 400 of FIG. 4A or 4B), according to some embodiments of the present disclosure. The system can include a meeting service 702, an annotation service 704, an annotation agent 706, and a meeting application 708. Annotation agent 706 and meeting application 708 may be part of a client 709, as shown.

At block 720, meeting service 702 may start an online meeting. For example, another client (not shown) may create a start a meeting hosted by meeting service 702. At line 721, meeting content may be synchronized between meeting service 702 and annotation service 704. For example, annotation service 704 may request meeting content using a SaaS API provided by meeting service 702. In other embodiments, the content may be captured by one or more clients participating in the meeting and at least one of the clients may send the content to annotation service 704. At block 722, annotation service 706 can analyze the meeting content to generate and store annotations for the meeting (e.g., within a database such as annotations database 452 of FIGS. 4A and 4B). Any of techniques disclosed herein for generating annotations from meeting content may be used.

At line 723, client 709 can join the online meeting hosted by meeting service 702. That is, meeting application 708 may communicate with meeting service 702 to join the meeting. In the example of FIG. 7, it is assumed at least some meeting content was communicated by other participants prior to client 709 joining the meeting. That is, client 709 is assumed to join the meeting late. Annotation agent 706—which may be a plugin or extension of meeting application 708 or otherwise interfaced therewith—can detect that client 709 joined the meeting (e.g., using an event handler interface provided by meeting application 708). In response, at line 725, annotation agent 706 can request annotations generated for the meeting from annotation service 704. At block 726, annotation service 704 can fetch annotations that were previously generated and stored for the meeting and, at line 727, can return the annotations to annotation agent 706. At block 728, annotation agent 706, in coordination with meeting application 708, can cause the annotations to be rendered on a meeting timeline. For example, annotation agent 706 can cause meeting application 708 to present a UI similar to that of FIGS. 5A-5C for displaying the annotations.

Asynchronous to the request and rendering of annotations by annotation agent 706, additional meeting content may be synced between meeting service 702 and annotation service 704 (line 729), and annotation service 704 can generate and store additional annotations (block 730). The interactions portrayed by lines 725, 727, and 729 and the processing portrayed by blocks 726, 728, and 738 may be repeated one or more times, as indicated by dashed arrow 731. For example, annotation service 704 can periodically receive new meeting content from meeting service 702 and generate and store annotations based thereon. Similarly, annotation agent 706 may periodically receive new annotations from annotation service 704 and render them on the meeting time.

After the meeting has ended (block 732), annotation agent can receive annotations generated for the entire meeting from annotation service 704 (line 733) and cause the annotations to be rendered on a meeting progress UI, such as the UI of FIG. 6. In some embodiments, annotation service 704 may detect when a meeting has ended and, in response, may push the annotations to annotation agent 706. In other embodiments, annotation agent 706 may detect when the meeting ends (e.g., using an event handler interface provided by meeting application 708) and, in response, may request the annotations from annotation service 704.

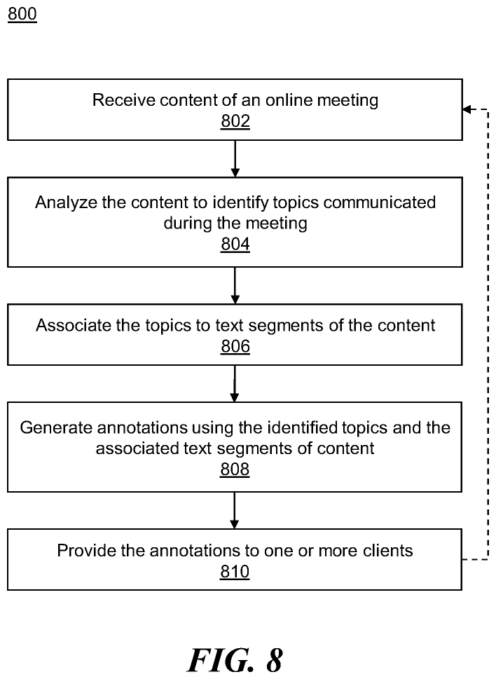

FIG. 8 shows an example of a method 800 for annotating online meetings that may be performed by (e.g., executed on) a server, according to some embodiments of the present disclosure. For example, method 800 may be performed by annotation service 406 of FIG. 4.

At block 802, content of an online meeting can be received. For example, the content may be received from an online meeting service using a SaaS API thereof or from a client participating in the meeting.

At block 804, the content can be analyzed to identify topics communicated by one or more clients participating in the meeting. In some embodiments, individual portions of the meeting's content may be analyzed to identify topics communicated during that portion of the meeting (e.g., during a particular period of time). In some embodiments, the content may include image data, video data, audio data, or other non-text data and method 800 can include a step for converting the non-text data. For example, in the case of image/video data, method 800 may use OCR to extract text from the image/video data. In the case of audio data, method 800 may use speech-to-text to convert the audio data to text. Any of techniques disclosed herein for generating annotations from meeting content may be used. For example, a trained topic model (e.g., an LDA model) may be used to identify the one or more topics within the text of the content.

At block 806, ones of the one or more topics may be associated with particular text segments of the content. Any of techniques disclosed herein for associating topics to text segments can be used. For example, in some cases, block 806 can include splitting the text of the content into the one or more text segments using natural language processing (NLP) and performing a string search of the one of the one or more topics within the one or more text segments.

At block 808, one or more meeting annotations can be generated using the topics identified at block 804 and the associated text segments from block 806. A generated annotation can include information/fields representing a particular topic, the segments associated with that topic, and a timestamp or other value indicating which portion of the meeting's content the topic was identified within.

At block 810, the annotations can be provided to at least one of the one or more client devices participating in the online meeting. The method 800 can be repeated periodically throughout the duration of a meeting, as indicated by the dashed arrow in FIG. 8.

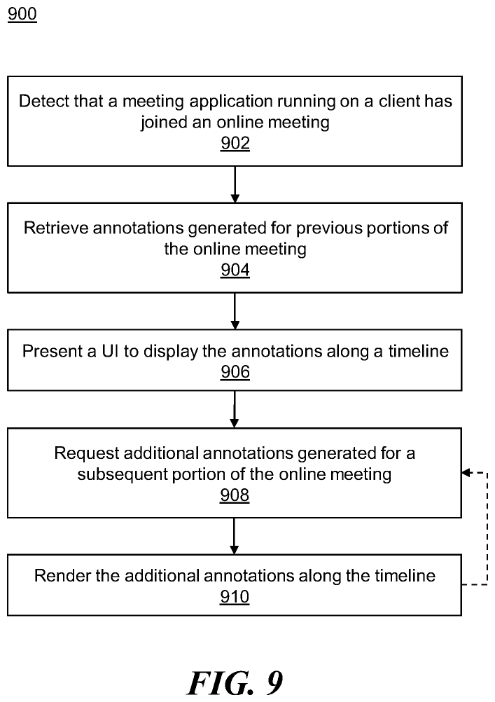

FIG. 9 shows an example of a method 900 for annotating online meetings that may be performed by (e.g., executed on) a client, according to some embodiments of the present disclosure. For example, method 800 may be performed by one of clients 402 of FIG. 4.

At block 902, the client can detect that a meeting application running thereon has joined an online meeting (i.e., is participating in the meeting). In some embodiments, an agent running on the client may perform the detection using an event interface provided by the meeting application.

At block 904, responsive to the detection, the client can send a request to a server (e.g., annotation service 406 of FIG. 4) to retrieve the annotations for the online meeting. In some embodiments, the server may provide an API for retrieving annotations and the client may send an API message that includes a unique identifier for the meeting. The annotations may correspond to annotations generated for portions of the meeting that occurred prior to the client joining. That is, the annotations may represent topics that were communicated by other clients before the client joined the meeting.

At block 906, the client may present a UI to display the annotations along a timeline. The annotations may be positioned along the timeline to indicate during which time periods of the online meeting the corresponding topics and associated text segments were communicated. For example, the client may present a UI within the meeting application similar to the UI shown in FIGS. 5A-5C.

At block 908, the client may request additional annotations generated for subsequent portions of the online meeting and, at block 910, can render the additional annotations within the UI along the meeting time. The method 900 can be repeated periodically throughout the duration of a meeting, as indicated by the dashed arrow in FIG. 9.

The following examples pertain to further embodiments, from which numerous permutations and configurations will be apparent.

Example 1 includes a method including: receiving, at a computing device, content of an online meeting; analyzing, by the computing device, the content to identify one or more topics communicated by one or more client devices participating in the online meeting; associating, by the computing device, ones of the one or more topics to one or more text segments of the content; and providing, by the computing device, annotations for the online meeting to at least one of the one or more client devices participating in the online meeting, the annotations representative of the one or more topics and the associated text segments.

Example 2 includes the subject matter of Example 1, wherein receiving the content of the online meeting includes receiving the content of the online meeting from one of the one or more client devices participating in the online meeting.

Example 3 includes the subject matter of Example 1 or 2, wherein receiving the content of the online meeting includes receiving the content of the online meeting from an online meeting service.

Example 4 includes the subject matter of any of Examples 1 to 3, wherein the content of the online meeting is a first portion of content of an online meeting communicated during a first time period, the one or more topics are one or more first topics, the one or more text segments are one or more first text segments, and the annotations are first annotations further representative of the first time period, the method further including: receiving a second portion of content of the online meeting associated with a second time period; analyzing the second portion of the content to identify one or more second topics communicated by the one or more client devices participating in the online meeting; associating ones of the one or more second topics to one or more second text segments of the second portion of the content; and providing second annotations for the online meeting to the at least one of the one or more client devices participating in the online meeting, the second annotations representative of the one or more topics and the associated text segments, and further representative of the second time period.

Example 5 includes the subject matter of any of Examples 1 to 5, wherein analyzing the content to identify the one or more topics includes: obtaining text of the content; and analyzing the text to identify the one or more topics.

Example 6 includes the subject matter of any of Examples 1 to 5, wherein analyzing the content to identify the one or more topics includes: utilizing a trained topic model to identify the one or more topics within the text of the content.

Example 7 includes the subject matter of any of Examples 1 to 6, wherein associating one of the one or more topics to the one or more text segments of the content includes: splitting the text of the content into the one or more text segments using natural language processing (NLP); and performing a string search of the one of the one or more topics within the one or more text segments.

Example 8 includes the subject matter of any of Examples 1 to 7, wherein the content includes audio data, wherein obtaining text of the content includes performing speech-to-text on the audio data.

Example 9 includes the subject matter of any of Examples 1 to 8, wherein the content includes video or image data, wherein obtaining text of the content includes performing optical character recognition (OCR) on the image data.

Example 10 includes a method including: receiving, by a client device, annotations for an online meeting from a server device, the annotations representing topics and associated text segments identified by the server device based on analysis of content of the online meeting; and displaying, by the client device, the annotations positioned along a timeline of the online meeting to indicate during which time periods of the online meeting the topics and associated text segments were communicated by one or more other client devices participating in the online meeting.

Example 11 includes the subject matter of Example 10, and further includes: detecting that a meeting application running on the client device is participating in the online meeting; and responsive to the detection, sending a request to the server device to retrieve the annotations for the online meeting.

Example 12 includes the subject matter of Example 10 or 11, and further includes: periodically sending additional requests to the server device to retrieve additional annotations for the online meeting; and displaying the additional annotations alone the timeline of the online meeting.

Example 13 includes the subject matter of any of Examples 1 to 12, wherein the annotations are displayed within the meeting application.

Example 14 includes an apparatus including a processor and a non-volatile memory storing computer program code that when executed on the processor causes the processor to execute a process. The process includes: receiving content of an online meeting; analyzing the content to identify one or more topics communicated by one or more client devices participating in the online meeting; associating ones of the one or more topics to one or more text segments of the content; and providing annotations for the online meeting to at least one of the one or more client devices participating in the online meeting, the annotations representative of the one or more topics and the associated text segments.

Example 15 includes the subject matter of Example 14, wherein receiving the content of the online meeting includes receiving the content of the online meeting from one of the one or more client devices participating in the online meeting.

Example 16 includes the subject matter of Example 14 or 15, wherein receiving the content of the online meeting includes receiving the content of the online meeting from an online meeting service.

Example 17 includes the subject matter of any of Examples 14 to 16, wherein the content of the online meeting is a first portion of content of an online meeting associated with a first time period, the one or more topics are one or more first topics, the one or more text segments are one or more first text segments, and the annotations are first annotations further representative of the first time period, wherein the process further including: receiving a second portion of content of the online meeting associated with a second time period; analyzing the second portion of the content to identify one or more second topics communicated by the one or more client devices participating in the online meeting; associating ones of the one or more second topics to one or more second text segments of the second portion of the content; and providing second annotations for the online meeting to the at least one of the one or more client devices participating in the online meeting, the second annotations representative of the one or more topics and the associated text segments, and further representative of the second time period.

Example 18 includes the subject matter of any of Examples 14 to 17, wherein analyzing the content to identify the one or more topics includes: obtaining text of the content; and analyzing the text to identify the one or more topics.

Example 19 includes the subject matter of any of Examples 14 to 18, wherein analyzing the content to identify the one or more topics includes: utilizing a trained topic model to identify the one or more topics within the text of the content.

Example 20 includes the subject matter of any of Examples 14 to 18, wherein associating the one of the one or more topics to the one or more text segments of the content includes: splitting the text of the content into the one or more text segments using natural language processing (NLP); and performing a string search of the one of the one or more topics within the one or more text segments.

The subject matter described herein can be implemented in digital electronic circuitry, or in computer software, firmware, or hardware, including the structural means disclosed herein and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or another unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this disclosure, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of nonvolatile memory, including by ways of example semiconductor memory devices, such as EPROM, EEPROM, flash memory device, or magnetic disks. The processor and the memory can be supplemented by, or incorporated in, special purpose logic circuitry.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described in connection knowledge of one skilled in the art to affect such feature, structure, or characteristic in connection with other embodiments whether or not explicitly described.

The disclosed subject matter is not limited in its application to the details of construction and to the arrangements of the components set forth in the following description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

All publications and references cited herein are expressly incorporated herein by reference in their entirety.

1. A method comprising:
receiving, at a computing device, content of an online meeting;
analyzing, by the computing device, the content to identify one or more topics communicated by one or more client devices participating in the online meeting;
associating, by the computing device, ones of the one or more topics to one or more text segments of the content; and
providing, by the computing device, annotations for the online meeting to at least one of the one or more client devices participating in the online meeting, the annotations representative of the one or more topics and the associated text segments.

2. The method of claim 1, wherein receiving the content of the online meeting includes receiving the content of the online meeting from one of the one or more client devices participating in the online meeting.

3. The method of claim 1, wherein receiving the content of the online meeting includes receiving the content of the online meeting from an online meeting service.

4. The method of claim 1, wherein the content of the online meeting is a first portion of content of an online meeting communicated during a first time period, the one or more topics are one or more first topics, the one or more text segments are one or more first text segments, and the annotations are first annotations further representative of the first time period, the method further comprising:
receiving a second portion of content of the online meeting associated with a second time period;
analyzing the second portion of the content to identify one or more second topics communicated by the one or more client devices participating in the online meeting;
associating ones of the one or more second topics to one or more second text segments of the second portion of the content; and
providing second annotations for the online meeting to the at least one of the one or more client devices participating in the online meeting, the second annotations representative of the one or more topics and the associated text segments, and further representative of the second time period.

5. The method of claim 1, wherein analyzing the content to identify the one or more topics includes:
obtaining text of the content; and
analyzing the text to identify the one or more topics.

6. The method of claim 5, wherein analyzing the content to identify the one or more topics includes:
utilizing a trained topic model to identify the one or more topics within the text of the content.

7. The method of claim 5, wherein associating one of the one or more topics to the one or more text segments of the content includes:
splitting the text of the content into the one or more text segments using natural language processing (NLP); and
performing a string search of the one of the one or more topics within the one or more text segments.

8. The method of claim 5, wherein the content includes audio data, wherein obtaining text of the content includes performing speech-to-text on the audio data.

9. The method of claim 5, wherein the content includes video or image data, wherein obtaining text of the content includes performing optical character recognition (OCR) on the image data.

10. A method comprising:
receiving, by a client device, annotations for an online meeting from a server device, the annotations representing topics and associated text segments identified by the server device based on analysis of content of the online meeting; and
displaying, by the client device, the annotations positioned along a timeline of the online meeting to indicate during which time periods of the online meeting the topics and associated text segments were communicated by one or more other client devices participating in the online meeting.

11. The method of claim 10, further comprising:
detecting that a meeting application running on the client device is participating in the online meeting; and
responsive to the detection, sending a request to the server device to retrieve the annotations for the online meeting.

12. The method of claim 11, further comprising:
periodically sending additional requests to the server device to retrieve additional annotations for the online meeting; and
displaying the additional annotations alone the timeline of the online meeting.

13. The method of claim 10, wherein the annotations are displayed within the meeting application.

14. An apparatus comprising:
a processor; and
a non-volatile memory storing computer program code that when executed on the processor causes the processor to execute a process comprising:
receiving content of an online meeting;
analyzing the content to identify one or more topics communicated by one or more client devices participating in the online meeting;
associating ones of the one or more topics to one or more text segments of the content; and
providing annotations for the online meeting to at least one of the one or more client devices participating in the online meeting, the annotations representative of the one or more topics and the associated text segments.

15. The apparatus of claim 14, wherein receiving the content of the online meeting includes receiving the content of the online meeting from one of the one or more client devices participating in the online meeting.

16. The apparatus of claim 14, wherein receiving the content of the online meeting includes receiving the content of the online meeting from an online meeting service.

17. The apparatus of claim 14, wherein the content of the online meeting is a first portion of content of an online meeting associated with a first time period, the one or more topics are one or more first topics, the one or more text segments are one or more first text segments, and the annotations are first annotations further representative of the first time period, wherein the process further comprising:
receiving a second portion of content of the online meeting associated with a second time period;
analyzing the second portion of the content to identify one or more second topics communicated by the one or more client devices participating in the online meeting;
associating ones of the one or more second topics to one or more second text segments of the second portion of the content; and
providing second annotations for the online meeting to the at least one of the one or more client devices participating in the online meeting, the second annotations representative of the one or more topics and the associated text segments, and further representative of the second time period.

18. The apparatus of claim 14, wherein analyzing the content to identify the one or more topics includes:
obtaining text of the content; and
analyzing the text to identify the one or more topics.

19. The apparatus of claim 18, wherein analyzing the content to identify the one or more topics includes:
utilizing a trained topic model to identify the one or more topics within the text of the content.

20. The apparatus of claim 18, wherein associating the one of the one or more topics to the one or more text segments of the content includes:
splitting the text of the content into the one or more text segments using natural language processing (NLP); and
performing a string search of the one of the one or more topics within the one or more text segments.
